(19) United States
(12) Patent Application Publication
(10) Pub. No.: US 2017/0353996 A1
(43) Pub. Date: Dec. 7, 2017

(54) TRANSPARENT SHEET HEATER

(71) Applicant: KOLON INDUSTRIES, INC., Gwacheon-si, Gyeonggi-do (KR)

(72) Inventors: Dae Hwan LEE, Siheung-si (KR); Dong Kyu KIM, Suwon-si (KR); Sang Min SONG, Seongnam-si (KR); Sang Kyun KIM, Yongin-si (KR); Song Yi HAN, Yongin-si (KR); Yeseul KIM, Seongnam-si (KR)

(73) Assignee: KOLON INDUSTRIES, INC., Gwacheon-si, Gyeonggi-do (KR)

(21) Appl. No.: 15/540,854

(22) PCT Filed: Dec. 31, 2015
(86) PCT No.: PCT/KR2015/014545

§ 371 Date: Jun. 29, 2017

(30) Foreign Application Priority Data
Dec. 31, 2014 (KR) 10-2014-0195094
Apr. 22, 2015 (KR) 10-2015-0056749
Apr. 22, 2015 (KR) 10-2015-0056762

(51) Int. Cl. H05B 3/84; H05B 3/14; H05B 3/12; H05B 3/20; H05B 3/16

(52) U.S. Cl. CPC H05B 3/84; H05B 3/20; H05B 3/16; H05B 3/12; H05B 3/141; H05B 3/145

(57) ABSTRACT

The present disclosure relates to: a transparent sheet heater including: a substrate; a pattern layer formed on the substrate; a heat-generating layer formed on the pattern layer and including a conductive material; and an electrode connected on the heat-generating layer; a transparent sheet heater including: a substrate; a heat-generating layer formed on the substrate and including a conductive material; an electrode connected on the heat-generating layer; and a protective layer formed on the heat-generating layer, wherein the protective layer includes pores; and a transparent sheet heater system which is formed by connecting the multiple transparent sheet heaters in series or in parallel.

### TECHNICAL FIELD

The present disclosure relates to a transparent sheet heater which is excellent in uniformity and exothermic properties.

### BACKGROUND

Various countries around the world have invested heavily in research on energy conservation in view of energy resource depletion. A sheet heater which has recently attracted a lot of attention with this trend is a product capable of reducing power consumption by about 20% to about 40% compared with a generally used electric heater, and, thus, it is expected to greatly conserve electric energy and have great economic effects.

Typically, a sheet heater uses radiant heat generated by electric conduction and thus can be easily controlled in temperature. Further, the sheet heater does not pollute the air and thus has advantages in terms of hygiene and noise. Therefore, the sheet heater has usually been used for bedding such as a heating mat or pad. Furthermore, the sheet heater has been widely used for floor heating in houses, industrial heating in offices and workplaces, heaters in various worksites for painting drying or the like, vinyl houses or stables, facilities for framing, rear view mirrors for vehicles, anti-freezing devices in parking lots, cold-proof equipment for leisure, home appliances, and the like.

Particularly in recent years, sheet heaters have been actively used and substituted for many parts for house heating, and the sheet heaters are expected to be highly usable both at home and abroad as a new material applicable to industrial dryers, agricultural product dryers, health and medical assistant devices, and building materials as well as the housing field.

Further, new application of sheet heaters to, for example, clothes or frame-type heaters in addition to the above-described uses has been continuously researched by modifying the composition and materials of the sheet heaters in various ways. Particularly, with the use of a material having both transparency and conductivity, application of sheet heaters has been expanded to the fields of windows and mirrors required to have transparency.

Due to these characteristics, a transparent conductive thin film which has been widely used for conventional touch screen panel (TSP) may be used as a sheet heater, and a representative material thereof is indium tin oxide (ITO). However, similar to the use for TSP, a vacuum process is basically needed to prepare an ITO thin film and requires a high processing cost. Also, indium used for ITO is a rare and expensive metal being expected to be depleted. Further, when a flexible display device is bent or folded, the thin film may be broken, resulting in a decrease in lifetime.

In order to substitute for ITO, technologies applying carbon nanotube, graphene, metal nanowire, and metal mesh grid as a conductive material of the transparent conductive film have been developed. Particularly, if metal nanowire or carbon nanotube having a one-dimensional structure forms an electric network and constitutes a conductive film, a film with a high electric conductivity can be prepared. Further, a material having a one-dimensional structure has a diameter of several nm to several ten nm and thus has excellent dispersibility. Therefore, when the material is prepared into a film, it is possible to obtain a transmittance of 85% or more in a visible light range.

However, while a conductive material, such as metal nanowire or carbon nanotube, having a constant aspect ratio is dispersed in a discontinuous phase, it may be uniformly dispersed in ink, but while the conductive material is dried as being coated on a substrate, aggregation may occur in the conductive material. A current applied in a state with poor uniformity does not uniformly flow, resulting in the local generation of high-temperature heat. Thus, non-uniform generation of heat or disconnection may occur.

Meanwhile, Korean Patent No. 10-1222639 discloses a transparent heater including graphene. However, this transparent heater also has poor uniformity while graphene is formed on a substrate and high-temperature heat is locally generated on graphene.

### DISCLOSURE OF THE INVENTION

### Problems to be Solved by the Invention

The present disclosure is conceived to solve the above-described problem and provides a transparent sheet heater including a substrate on which a pattern is formed; a transparent sheet heater in which a protective layer including pores is formed; and a transparent sheet heater system formed by connecting the multiples transparent sheet heaters in series or in parallel.

However, problems to be solved by the present disclosure are not limited to the above-described problems. Although not described herein, other problems to be solved by the present disclosure can be clearly understood by those skilled in the art from the following description.

### Means for Solving the Problems

A first aspect of the present disclosure provides a transparent sheet heater including: a substrate; a pattern layer formed on the substrate; a heat-generating layer formed on the pattern layer and including a conductive material; and an electrode connected on the heat-generating layer.

According to an exemplary embodiment of the present disclosure, the substrate may be transparent, but may not be limited thereto.

According to an exemplary embodiment of the present disclosure, the substrate may include a silicon substrate, a glass substrate, or a polymer substrate, but may not be limited thereto.

According to an exemplary embodiment of the present disclosure, the pattern layer may be formed of a curable resin, but may not be limited thereto.

According to an exemplary embodiment of the present disclosure, the pattern layer may have a shape selected from the group consisting of intaglio, relief, and combinations thereof, but may not be limited thereto.

According to an exemplary embodiment of the present disclosure, the pattern layer may include a regular or amorphous pattern, but may not be limited thereto.

According to an exemplary embodiment of the present disclosure, the pattern layer may include a pattern with a gap of from about 1 μm to about 500 μm, but may not be limited thereto.

According to an exemplary embodiment of the present disclosure, the conductive material may include a member selected from the group consisting of a metal oxide, a metal nanowire, a carbon nanostructure, a metal paste, metal nanoparticles, and combinations thereof, but may not be limited thereto. For example, the metal oxide may include a metal oxide selected from the group consisting of indium tin oxide (ITO), zinc tin oxide (ZTO), indium gallium zinc oxide (IGZO), zinc aluminum oxide (ZAO), indium zinc oxide (IZO), zinc oxide (ZnO), and combinations thereof, the metal nanowire may include a metal nanowire selected from the group consisting of silver, gold, platinum, cooper, nickel, aluminum, titanium, palladium, cobalt, cadmium, rhodium, and combinations thereof, the carbon nanostructure may include a member selected from the group consisting of graphene, carbon nanotube, fullerene, carbon black, and combinations thereof, the metal paste may include a metal selected from the group consisting of silver, gold, platinum, cooper, nickel, aluminum, titanium, palladium, cobalt, cadmium, rhodium, and combinations thereof, and the metal nanoparticles may include a metal selected from the group consisting of silver, gold, platinum, cooper, nickel, aluminum, titanium, palladium, cobalt, cadmium, rhodium, and combinations thereof.

According to an exemplary embodiment of the present disclosure, the heat-generating layer may have a thickness of from about 10 nm to about 500 nm, but may not be limited thereto.

According to an exemplary embodiment of the present disclosure, the transparent sheet heater may further include a protective layer formed on the heat-generating layer, but may not be limited thereto.

According to an exemplary embodiment of the present disclosure, the heat-generating layer may be formed along a pattern shape of the pattern layer, but may not be limited thereto.

According to an exemplary embodiment of the present disclosure, the transparent sheet heater may include an air gap formed between the protective layer and the heat-generating layer formed along the pattern shape, but may not be limited thereto.

According to an exemplary embodiment of the present disclosure, the protective layer may have a thickness of 50 nm to 200 μm, but may not be limited thereto.

According to an exemplary embodiment of the present disclosure, the protective layer may include pores, but may not be limited thereto.

According to an exemplary embodiment of the present disclosure, the pores in the protective layer may have a size of 5 nm to 10 μm, but may not be limited thereto.

According to an exemplary embodiment of the present disclosure, when power is applied through the electrode, the heat-generating layer may generate heat, but may not be limited thereto.

According to an exemplary embodiment of the present disclosure, the electrode may include a transparent electrode, but may not be limited thereto.

According to an exemplary embodiment of the present disclosure, the electrode may include a member selected from the group consisting of silver, gold, platinum, aluminum, cooper, chromium, vanadium, magnesium, titanium, tin, lead, palladium, tungsten, nickel, alloys thereof, ITO, metal nanowire, carbon nanostructure, and combinations thereof, but may not be limited thereto.

According to an exemplary embodiment of the present disclosure, the electrode may include a pair or more of electrodes, but may not be limited thereto.

A second aspect of the present disclosure provides a transparent sheet heater including: a substrate; a heat-generating layer formed on the substrate and including a conductive material; an electrode connected on the heat-generating layer; and a protective layer formed on the heat-generating layer, and the protective layer includes pores.

According to an exemplary embodiment of the present disclosure, the substrate may be transparent, but may not be limited thereto.

According to an exemplary embodiment of the present disclosure, the substrate may include a silicon substrate, a glass substrate, or a polymer substrate, but may not be limited thereto.

According to an exemplary embodiment of the present disclosure, the conductive material may include a member selected from the group consisting of a metal oxide, a metal nanowire, a carbon nanostructure, a metal paste, metal nanoparticles, and combinations thereof, but may not be limited thereto. For example, the metal oxide may include a metal oxide selected from the group consisting of indium tin oxide (ITO), zinc tin oxide (ZTO), indium gallium zinc oxide (IGZO), zinc aluminum oxide (ZAO), indium zinc oxide (IZO), zinc oxide (ZnO), and combinations thereof, the metal nanowire may include a metal nanowire selected from the group consisting of silver, gold, platinum, cooper, nickel, aluminum, titanium, palladium, cobalt, cadmium, rhodium, and combinations thereof, the carbon nanostructure may include a member selected from the group consisting of graphene, carbon nanotube, fullerene, carbon black, and combinations thereof, the metal paste may include a metal selected from the group consisting of silver, gold, platinum, cooper, nickel, aluminum, titanium, palladium, cobalt, cadmium, rhodium, and combinations thereof, and the metal nanoparticles may include a metal selected from the group consisting of silver, gold, platinum, cooper, nickel, aluminum, titanium, palladium, cobalt, cadmium, rhodium, and combinations thereof.

According to an exemplary embodiment of the present disclosure, the heat-generating layer may have a thickness of from about 10 nm to about 500 nm, but may not be limited thereto.

According to an exemplary embodiment of the present disclosure, the protective layer may have a thickness of 50 nm to 200 μm, but may not be limited thereto.

According to an exemplary embodiment of the present disclosure, pores in the protective layer may have a size of 5 nm to 10 μm, but may not be limited thereto.

According to an exemplary embodiment of the present disclosure, when power is applied through the electrode, the heat-generating layer may generate heat, but may not be limited thereto.

According to an exemplary embodiment of the present disclosure, the electrode may include a transparent electrode, but may not be limited thereto.

According to an exemplary embodiment of the present disclosure, the electrode may include a member selected from the group consisting of silver, gold, platinum, aluminum, cooper, chromium, vanadium, magnesium, titanium, tin, lead, palladium, tungsten, nickel, alloys thereof, ITO, metal nanowire, carbon nanostructure, and combinations thereof, but may not be limited thereto.

According to an exemplary embodiment of the present disclosure, the electrode may include a pair or more of electrodes, but may not be limited thereto.

A third aspect of the present disclosure provides a transparent sheet heater system formed by connecting the multiple transparent sheet heaters according to the first or second aspect of the present disclosure in series or in parallel.

### Effects of the Invention

According to the present disclosure, a pattern layer is formed on a substrate of a transparent sheet heater. Thus, within a heat-generating layer including a conductive material, it is possible to physically suppress aggregation occurring in the conductive material and thus possible to improve the uniformity of the conductive material in the heat-generating layer. Also, it is possible to improve the heat generation efficiency and lifetime of the transparent sheet heater. Further, the transparent sheet heater according to the present disclosure exhibits a low resistance and a high transmittance and thus can be applied for various uses.

Furthermore, the transparent sheet heater according to the present disclosure includes an air gap formed between the heat-generating layer and the protective layer and pores within the protective layer and thus can improve an insulation effect by minimizing heat loss occurring in the heat-generating layer.

### BRIEF DESCRIPTION OF THE DRAWINGS

FIG. 1 is a structure diagram of a transparent sheet heater in accordance with an exemplary embodiment of the present disclosure.

FIG. 2 is a structure diagram of a transparent sheet heater in accordance with an exemplary embodiment of the present disclosure.

FIG. 3 is a structure diagram of a transparent sheet heater in accordance with an exemplary embodiment of the present disclosure.

FIG. 4 is a structure diagram of a transparent sheet heater in accordance with an exemplary embodiment of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art.

However, it is to be noted that the present disclosure is not limited to the embodiments and examples but can be embodied in various other ways. In drawings, parts irrelevant to the description are omitted for simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the another element and a case that any other element exists between these two elements.

Through the whole document, the term “comprises or includes” and/or “comprising or including” used in the document means that one or more other components, steps, operation and/or existence or addition of elements are not excluded in addition to the described components, steps, operation and/or elements unless context dictates otherwise.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party. Through the whole document, the term “step of” does not mean “step for”.

Through the whole document, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A, B, or A and B”.

Hereinafter, a transparent surface heater of the present disclosure will be described in detail with reference to embodiments, examples and drawings of the present disclosure. However, the present disclosure may not be limited to the embodiments, examples and drawings.

A first aspect of the present disclosure provides a transparent sheet heater including: a substrate 100; a pattern layer 200 formed on the substrate; a heat-generating layer 300 formed on the pattern layer and including a conductive material; and an electrode 400 connected on the heat-generating layer.

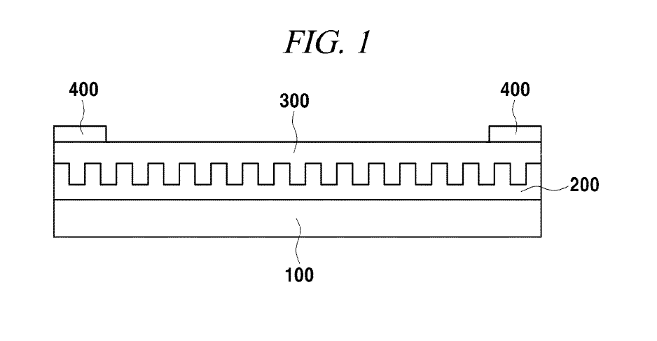

FIG. 1 to FIG. 3 are structure diagrams of a transparent sheet heater in which the pattern layer 200 is formed in accordance with an exemplary embodiment of the present disclosure.

The transparent sheet heater includes the substrate 100.

In an exemplary embodiment of the present disclosure, the substrate 100 may be transparent. The substrate 100 may include a typically usable substrate, for example, a silicon substrate, a glass substrate, or a polymer substrate, but may not be limited thereto.

The silicon substrate may include, for example, a monosilicon substrate or a p-Si substrate, the glass substrate may include, for example, alkali silicate-based glass, alkali-free glass, or quartz glass, and the polymer substrate may include, for example, polyimide, polyethersulfone, polyetheretherketone, polyethylene terephthalate, polybutylene terephthalate, polycarbonate, polyacrylate, or polyurethane, but may not be limited thereto.

The pattern layer 200 is formed on the substrate 100.

The pattern layer 200 includes a pattern having an uneven shape including a concave portion and a convex portion, and the pattern may have a shape selected from the group consisting of, for example, intaglio, relief, and combinations thereof, but may not be limited thereto. Further, the pattern may include a regular pattern with regular arrangement or amorphous pattern with irregular arrangement, but may not be limited thereto.

The conductive material included in the heat-generating layer 300 formed on the pattern layer 200 is uniformly dispersed within the heat-generating layer 300 corresponding to the pattern. Thus, it is possible to physically suppress aggregation of the conductive material. Therefore, the uniformity of the conductive material included in the heat-generating layer 300 is improved. Since the conductive material is uniformly dispersed within the heat-generating layer 300, a current applied to the heat-generating layer 300 can uniformly flow in the entire heat-generating layer 300. Therefore, it is possible to the heat generation efficiency and heat generation lifetime of the transparent sheet heater.

In an exemplary embodiment of the present disclosure, the pattern layer 200 may be formed by directly patterning the substrate 100, or may be formed of a curable resin formed on the substrate 100. The curable resin can be used without limitation as long as it can form a pattern with heat or via irradiation of light such as ultraviolet (UV) light.

A thermosetting resin which can form a pattern with heat may include a member selected from the group consisting of, for example, 1,6-hexanediol(meta)acrylate, ethylene glycol diacrylate, neopentyl glycol di(meta)acrylate, trimethylolpropane tri(meta)acrylate, dipentaerythritol hexa(meth)acrylate, polyol poly(meta)acrylate, polyalcohol, polycarboxylic acid, poly ester (meta)acrylate which can be obtained via esterification of its anhydride and acrylic acid, di(meta)acrylate of bisphenol A-digylicidyl ether, polysiloxane polyacrylate, urethane(meta)acrylate, pentaerythritol tetrametacrylate, glycerin trimethacrylate, fluorine-containing epoxy acrylate, fluorine-containing alkoxy silane, 2-(perfluorodecyl)ethyl methacrylate, 3-perfluorooctyl-2-hydroxy propyl acrylate, 3-(perfluoro-9-methyldecyl)-1,2-epoxy propane, (meth)acrylic acid-2,2,2-trifluoroethyl, 3,3-trifluoropropyl, (meth)acrylic acid-2-trifluoromethyl, and combinations thereof, but may not be limited thereto.

A photocurable resin which can form a pattern via irradiation of light such as UV may include a member selected from the group consisting of, for example, polyester acrylate, epoxy acrylate, urethane acrylate, polyether acrylate, silicon acrylate, alicyclic epoxy resin, glycidyl ether epoxy resin, epoxy acrylate, vinyl ether, and combinations thereof, but may not be limited thereto.

According to an exemplary embodiment of the present disclosure, the pattern layer may include a pattern with a gap of from about 1 μm to about 500 μm, but may not be limited thereto. For example, the pattern may have a gap of from about 10 μm to about 400 μm, from about 50 μm to about 300 μm, from about 100 μm to about 200 μm, from about 1 μm to about 400 μm, from about 1 μm to about 300 μm, from about 1 μm to about 200 μm, from about 1 μm to about 100 μm, from about 1 μm to about 50 μm, from about 1 μm to about 30 μm, from about 1 μm to about 20 μm, from about 1 μm to about 10 μm, from about 10 μm to about 500 μm, from about 50 μm to about 500 μm, from about 100 μm to about 500 μm, from about 200 μm to about 500 μm, from about 300 μm to about 500 μm, from about 400 μm to about 500 μm, from about 100 μm to about 400 μm, or from about 200 μm to about 300 μm, but may not be limited thereto. If the pattern has a gap of more than about 500 μm, the transmittance is decreased and haze (Hz) which refers to the proportion of scattered light/transmitted light is increased. If the pattern has a gap of less than about 1 μm, the conductive material may not be uniformly dispersed, and, thus, the effect of the present disclosure cannot be achieved.

The heat-generating layer 300 includes a conductive material.

The conductive material may include an inkable material to which a low-priced process can be performed, but may not be limited thereto. The heat-generating layer 300 may be formed into a film or thin film by coating a solution including the conductive material on the pattern layer 200.

Referring to FIG. 1, in the heat-generating layer 300 formed by coating a solution including the conductive material, a surface of the heat-generating layer 300 may be formed along a pattern shape on the pattern layer 200 and the other surface may be flat without a pattern shape.

In an exemplary embodiment of the present disclosure, the heat-generating layer 300 may be formed along the pattern shape of the pattern layer 200, but may not be limited thereto. The heat-generating layer 300 may be formed into a film or thin film along the pattern shape by depositing a material including the conductive material on the pattern layer 200.

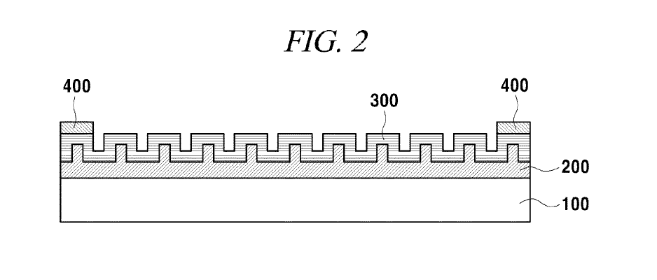

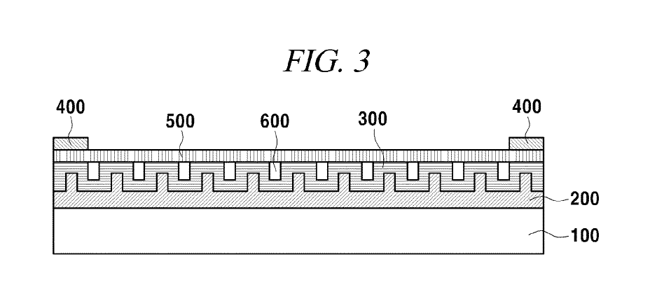

Referring to FIG. 2 and FIG. 3, in the heat-generating layer 300 formed by depositing a material including the conductive material, both surfaces of the heat-generating layer 300 may be formed along a pattern shape on the pattern layer 200.

The heat-generating layer 300 includes a pattern having an uneven shape including a concave portion and a convex portion, and the pattern may have a shape selected from the group consisting of, for example, intaglio, relief, and combinations thereof, but may not be limited thereto. Further, the pattern may be a regular pattern with regular arrangement or amorphous pattern with irregular arrangement, but may not be limited thereto.

The coating or depositing of the solution or material including the conductive material may be performed by various methods known in the art. For example, the methods may include spray coating, bar coating, dip coating, spin coating, slit die coating, curtain coating, gravure coating, reverse gravure coating, roll coating, or impregnation, but may not be limited thereto.

The solution including the conductive material is a solution in which the conductive material in an amount of from about 0.1 wt % to about 1.5 wt % is dispersed as solids in a solvent such as water or alcohol. If a solution including the conductive material in an amount of less than about 0.1 wt % is coated, a network is not sufficiently formed in the conductive material, and, thus, a sheet resistance may not be generated. As for a solution including the conductive material in an amount of more than about 1.5 wt %, a large amount of the conductive material in the solution aggregates. Even after the solution is coated, aggregates remain and may affect optical properties. Also, the viscosity is increased, which is not effective in forming a pattern.

In an exemplary embodiment of the present disclosure, the conductive material may include a member selected from the group consisting of a metal oxide, a metal nanowire, a carbon nanostructure, a metal paste, metal nanoparticles, and combinations thereof, but may not be limited thereto.

For example, the metal oxide may include a metal oxide selected from the group consisting of indium tin oxide (ITO), zinc tin oxide (ZTO), indium gallium zinc oxide (IGZO), zinc aluminum oxide (ZAO), indium zinc oxide (IZO), zinc oxide (ZnO), and combinations thereof, but may not be limited thereto. By coating or depositing a solution or material including the metal oxide on the pattern layer 200, the heat-generating layer 300 may be formed into a film or thin film.

For example, the metal nanowire may include a metal nanowire selected from the group consisting of silver, gold, platinum, cooper, aluminum, titanium, and combinations thereof, but may not be limited thereto. A silver nanowire is excellent in transparency and conductivity, and when a voltage is applied to a film including the silver nanowire, an excellent heat generation efficiency can be obtained. By coating or depositing a solution or material including the metal nanowire on the pattern layer 200, the heat-generating layer 300 may be formed into a film or thin film.

For example, the carbon nanostructure may include a member selected from the group consisting of graphene, carbon nanotube, fullerene, carbon black, and combinations thereof, but may not be limited thereto. By coating or depositing a solution or material including the carbon nanostructure on the pattern layer 200, the heat-generating layer 300 may be formed into a film or thin film.

For example, the metal paste or the metal nanoparticles may be paste or nanoparticles of a metal selected from the group consisting of silver, gold, platinum, cooper, aluminum, titanium, and combinations thereof, but may not be limited thereto. By coating or depositing the metal paste on the pattern layer 200, the heat-generating layer 300 may be formed into a film or thin film. By coating or depositing a solution or material including the metal nanoparticles on the pattern layer 200, the heat-generating layer 300 may be formed into a film or thin film.

In an exemplary embodiment of the present disclosure, the heat-generating layer 300 may have a thickness of from about 10 nm to about 500 nm, but may not be limited thereto. For example, the heat-generating layer 300 may have a thickness of from about 10 nm to about 400 nm, from about 50 nm to about 300 nm, from about 100 nm to about 200 nm, from about 10 nm to about 300 nm, from about 10 nm to about 200 nm, from about 10 nm to about 100 nm, from about 10 nm to about 50 nm, from about 10 nm to about 30 nm, from about 10 nm to about 20 nm, from about 10 nm to about 500 nm, from about 50 nm to about 500 nm, from about 100 nm to about 500 nm, from about 200 nm to about 500 nm, from about 300 nm to about 500 nm, from about 400 nm to about 500 nm, from about 100 nm to about 400 nm, or from about 200 nm to about 300 nm, but may not be limited thereto. If the thickness is more than 500 nm, a resistance is decreased and a transmittance is also decreased, but optical properties such as a haze (Hz) and a yellow index (YI) are increased. If the thickness is less than 10 nm, a high resistance value can be obtained. Desirably, the thickness may be from about 30 nm to about 300 nm.

In an exemplary embodiment of the present disclosure, the transparent sheet heater according to the present disclosure may further include a protective layer 500 formed on the heat-generating layer 300 to protect the heat-generating layer 300. The protective layer 500 may be, for example, a transparent polymer resin, and may be formed into a film or thin film, but may not be limited thereto.

For example, the transparent sheet heater includes a protective layer (not illustrated) formed on the heat-generating layer 300 formed by coating a solution including the conductive material, or may include the protective layer 500 formed on the heat-generating layer 300 formed by depositing a material including the conductive material.

In an exemplary embodiment of the present disclosure, the transparent sheet heater may further include an air gap 600 formed between the protective layer 500 and the heat-generating layer 300 formed along the pattern shape, as illustrated in FIG. 3.

In an exemplary embodiment of the present disclosure, when power is applied through the electrode 400, the heat-generating layer 300 generates heat. With the air gap 600 formed between the protective layer 500 and the heat-generating layer 300 formed along the pattern shape, an insulation effect can be improved by minimizing heat loss occurring in the heat-generating layer 300.

In an exemplary embodiment of the present disclosure, the protective layer 500 may include pores (not illustrated). The pores may be formed within the protective layer 500, and the pores within the protective layer trap air within the micro pores and convection of the air trapped within the micro pores is suppressed. Thus, an insulation effect can be improved by minimizing heat loss occurring in the heat-generating layer 300.

In an exemplary embodiment of the present disclosure, the protective layer 500 may have a thickness of from about 50 nm to about 300 nm or from about 50 nm to about 200 μm, but may not be limited thereto. For example, the protective layer 500 may have a thickness of from about 70 nm to about 200 μm, from about 100 nm to about 200 μm, from about 200 nm to about 200 μm, from about 300 nm to about 200 μm, from about 400 nm to about 200 μm, from about 500 nm to about 200 μm, from about 750 nm to about 200 μm, from about 1 μm to about 200 μm, from about 10 μm to about 200 μm, from about 100 μm to about 200 μm, from about 150 μm to about 200 μm, from about 50 nm to about 150 μm, from about 50 nm to about 100 μm, from about 50 nm to about 10 μm, from about 50 nm to about 1 μm, from about 50 nm to about 800 nm, from about 50 nm to about 600 nm, from about 50 nm to about 400 nm, from about 50 nm to about 200 nm, from about 50 nm to about 100 nm, from about 70 nm to about 150 μm, from about 100 nm to about 100 μm, from about 500 nm to about 50 μm, or from about 1 μm to about 10 μm, but may not be limited thereto. If the thickness is less than 50 nm, a function of protecting the heat-generating layer may deteriorate or there may be a problem with reliability. Desirably, the thickness may be from about 100 nm to about 200 nm.

In an exemplary embodiment of the present disclosure, the pores in the protective layer may have a size of from about 5 nm to about 10 μm, but may not be limited thereto. For example, the protective layer may have a pore size of from about 5 nm to about 10 μm, from about 10 nm to about 10 μm, from about 50 nm to about 10 μm, from about 100 nm to about 10 μm, from about 500 nm to about 10 μm, from about 1 μm to about 10 μm, from about 5 μm to about 10 μm, from about 5 nm to about 5 μm, from about 10 nm to about 1 μm, from about 50 nm to about 900 nm, from about 100 nm to about 800 nm, from about 200 nm to about 700 nm, from about 300 nm to about 600 nm, or from about 400 nm to about 500 nm, but may not be limited thereto. If the pores have a size similar to a wavelength of light, a coating layer becomes opaque. Therefore, more desirably, the pores may have a size of several hundred nanometers or less which is much smaller than the wavelength of light.

In an exemplary embodiment of the present disclosure, the protective layer 500 including the pores may have a porosity of from about 20% to about 70%, but may not be limited thereto. For example, the porosity may be from about 20% to about 70%, from about 30% to about 70%, from about 40% to about 70%, from about 50% to about 70%, from about 60% to about 70%, from about 20% to about 60%, from about 20% to about 50%, from about 20% to about 40%, or from about 20% to about 30%, but may not be limited thereto. If the porosity of the protective layer is less than about 20%, the insulation effect may deteriorate. If the porosity of the protective layer is more than about 70%, the protective layer becomes opaque, and, thus, the optical properties of the transparent sheet heater may deteriorate.

In an exemplary embodiment of the present disclosure, when power is applied through the electrode 400, the heat-generating layer 300 generates heat.

In an exemplary embodiment of the present disclosure, the electrode 400 may include any material without limitation as long as it is conductive, and may be transparent, but may not be limited thereto. For example, the electrode may include a member selected from the group consisting of silver, gold, platinum, aluminum, copper, chromium, vanadium, magnesium, titanium, tin, lead, palladium, tungsten, nickel, alloys thereof, ITO, a metal nanowire, a carbon nanostructure, and combinations thereof, but may not be limited thereto. For example, the metal nanowire may include a metal nanowire selected from the group consisting of silver, gold, platinum, cooper, aluminum, titanium, and combinations thereof, but may not be limited thereto. For example, the carbon nanostructure may include a member selected from the group consisting of graphene, carbon nanotube, fullerene, carbon black, and combinations thereof, but may not be limited thereto.

In an exemplary embodiment of the present disclosure, the electrode 400 may be formed on the heat-generating layer 300 or the protective layer 500, but may not be limited thereto. The electrode 400 may be a pair or more of electrodes. The electrode 400 may be formed by various wet coating and dry coating processes. For example, the electrode 400 may be formed by gravure printing, flexo printing, comma printing, slit coating, spray coating, screen printing, offset printing, laminating, lift-off, sputtering, ion plating, chemical vapor deposition, plasma chemical vapor deposition, thermal deposition, laser molecular beam deposition, pulse laser deposition, or atomic layer deposition, but may not be limited thereto.

A second aspect of the present disclosure provides a transparent sheet heater including: a substrate 100; a heat-generating layer 300 formed on the substrate and including a conductive material; an electrode 400 connected on the heat-generating layer; and a protective layer 500 formed on the heat-generating layer, and the protective layer includes pores 700.

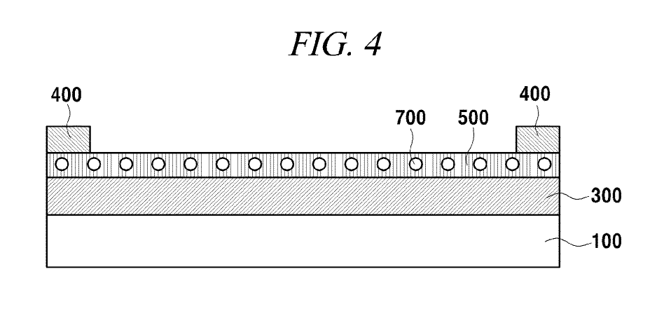

FIG. 4 is a structure diagram of a transparent sheet heater in which the protective layer 500 including the pores 700 is formed in accordance with an exemplary embodiment of the present disclosure.

The transparent sheet heater includes the substrate 100.

In an exemplary embodiment of the present disclosure, the substrate 100 may be transparent. The substrate 100 may include a typically usable substrate, for example, a silicon substrate, a glass substrate, or a polymer substrate, but may not be limited thereto.

The silicon substrate may include, for example, a monosilicon substrate or a p-Si substrate, the glass substrate may include, for example, alkali silicate-based glass, alkali-free glass, or quartz glass, and the polymer substrate may include, for example, polyimide, polyethersulfone, polyetheretherketone, polyethylene terephthalate, polybutylene terephthalate, polycarbonate, polyacrylate, or polyurethane, but may not be limited thereto.

The heat-generating layer 300 is formed on the substrate 100.

The conductive material included in the heat-generating layer 300 formed on the substrate 100 is uniformly dispersed. Thus, it is possible to physically suppress aggregation of the conductive material. Therefore, the uniformity of the conductive material included in the heat-generating layer 300 is improved. Since the conductive material is uniformly dispersed within the heat-generating layer 300, a current applied to the heat-generating layer 300 can uniformly flow in the entire heat-generating layer 300. Therefore, it is possible to the heat generation efficiency and lifetime of the transparent sheet heater.

The heat-generating layer 300 includes a conductive material.

In an exemplary embodiment of the present disclosure, the conductive material may include an inkable material to which a low-priced process can be performed, but may not be limited thereto. The heat-generating layer 300 may be formed into a film or thin film by coating or depositing a solution or material including the conductive material on the substrate 100.

In an exemplary embodiment of the present disclosure, the coating or depositing of the solution or material including the conductive material may be performed by various methods known in the art. For example, the methods may include spray coating, bar coating, dip coating, spin coating, slit die coating, curtain coating, gravure coating, reverse gravure coating, roll coating, or impregnation, but may not be limited thereto.

The solution including the conductive material is a solution in which the conductive material in an amount of from about 0.1 wt % to about 1.5 wt % is dispersed as solids in a solvent such as water or alcohol. If a solution including the conductive material in an amount of less than about 0.1 wt % is coated, a network is not sufficiently formed in the conductive material, and, thus, a sheet resistance may not be generated. As for a solution including the conductive material in an amount of more than about 1.5 wt %, a large amount of the conductive material in the solution aggregates. Even after the solution is coated, aggregates remain and may affect optical properties. Also, the viscosity is increased, which is not effective in forming a pattern.

In an exemplary embodiment of the present disclosure, the conductive material may include a member selected from the group consisting of a metal oxide, a metal nanowire, a carbon nanostructure, a metal paste, metal nanoparticles, and combinations thereof, but may not be limited thereto.

For example, the metal oxide may include a metal oxide selected from the group consisting of indium tin oxide (ITO), zinc tin oxide (ZTO), indium gallium zinc oxide (IGZO), zinc aluminum oxide (ZAO), indium zinc oxide (IZO), zinc oxide (ZnO), and combinations thereof, but may not be limited thereto. By coating or depositing a solution or material including the metal oxide on the substrate 100, the heat-generating layer 300 may be formed into a film or thin film.

For example, the metal nanowire may include a metal nanowire selected from the group consisting of silver, gold, platinum, cooper, nickel, aluminum, titanium, palladium, cobalt, cadmium, rhodium, and combinations thereof, but may not be limited thereto. A silver nanowire is excellent in transparency and conductivity, and when a voltage is applied to a film including the silver nanowire, an excellent heat generation efficiency can be obtained. By coating or depositing a solution or material including the metal nanowire on the substrate 100, the heat-generating layer 300 may be formed into a film or thin film.

For example, the carbon nanostructure may include a member selected from the group consisting of graphene, carbon nanotube, fullerene, carbon black, and combinations thereof, but may not be limited thereto. By coating or depositing a solution or material including the carbon nanostructure on the substrate 100, the heat-generating layer 300 may be formed into a film or thin film.

For example, the metal paste or the metal nanoparticles may be paste or nanoparticles of a metal selected from the group consisting of silver, gold, platinum, cooper, nickel, aluminum, titanium, palladium, cobalt, cadmium, rhodium, and combinations thereof, but may not be limited thereto. By coating or depositing the metal paste on the substrate 100, the heat-generating layer 300 may be formed into a film or thin film. By coating or depositing a solution or material including the metal nanoparticles on the substrate 100, the heat-generating layer 300 may be formed into a film or thin film.

In an exemplary embodiment of the present disclosure, the heat-generating layer 300 may have a thickness of from about 10 nm to about 500 nm, but may not be limited thereto. For example, the heat-generating layer 300 may have a thickness of from about 10 nm to about 400 nm, from about 50 nm to about 300 nm, from about 100 nm to about 200 nm, from about 10 nm to about 300 nm, from about 10 nm to about 200 nm, from about 10 nm to about 100 nm, from about 10 nm to about 50 nm, from about 10 nm to about 30 nm, from about 10 nm to about 20 nm, from about 10 nm to about 500 nm, from about 50 nm to about 500 nm, from about 100 nm to about 500 nm, from about 200 nm to about 500 nm, from about 300 nm to about 500 nm, from about 400 nm to about 500 nm, from about 100 nm to about 400 nm, or from about 200 nm to about 300 nm, but may not be limited thereto. If the thickness is more than 500 nm, a resistance is decreased and a transmittance is also decreased, but optical properties such as a haze (Hz) and a yellow index (YI) are increased. If the thickness is less than 10 nm, a high resistance value can be obtained. Desirably, the thickness may be from about 30 nm to about 300 nm.

In an exemplary embodiment of the present disclosure, in the transparent sheet heater according to the present disclosure, a protective layer 500 is formed on the heat-generating layer 300 to protect the heat-generating layer 300 and the protective layer 500 includes pores 700. The protective layer 500 may be, for example, a transparent polymer resin, and may be formed into a film or thin film, but may not be limited thereto.

In an exemplary embodiment of the present disclosure, the protective layer 500 may include the pores 700. The pores 700 may be formed within the protective layer 500, and the pores 700 within the protective layer trap air within the micro pores and convection of the air trapped within the micro pores is suppressed. Thus, an insulation effect can be improved by minimizing heat loss occurring in the heat-generating layer 300.

In an exemplary embodiment of the present disclosure, the protective layer 500 may have a thickness of from about 50 nm to about 200 μm, but may not be limited thereto. For example, the protective layer 500 may have a thickness of from about 70 nm to about 200 μm, from about 100 nm to about 200 μm, from about 200 nm to about 200 μm, from about 300 nm to about 200 μm, from about 400 nm to about 200 μm, from about 500 nm to about 200 μm, from about 750 nm to about 200 μm, from about 1 μm to about 200 μm, from about 10 μm to about 200 μm, from about 100 μm to about 200 μm, from about 150 μm to about 200 μm, from about 50 nm to about 150 μm, from about 50 nm to about 100 μm, from about 50 nm to about 10 μm, from about 50 nm to about 1 μm, from about 50 nm to about 800 nm, from about 50 nm to about 600 nm, from about 50 nm to about 400 nm, from about 50 nm to about 200 nm, from about 50 nm to about 100 nm, from about 70 nm to about 150 μm, from about 100 nm to about 100 μm, from about 500 nm to about 50 μm, or from about 1 μm to about 10 μm, but may not be limited thereto. If the thickness of the protective layer 500 is less than 50 nm, a function of protecting the heat-generating layer 300 may deteriorate or there may be a problem with reliability. Desirably, the thickness may be from about 100 nm to about 200 nm.

In an exemplary embodiment of the present disclosure, the pores 700 in the protective layer may have a size of from about 5 nm to about 10 μm, but may not be limited thereto. For example, the pores 700 in the protective layer may have a size of from about 5 nm to about 10 μm, from about 10 nm to about 10 μm, from about 50 nm to about 10 μm, from about 100 nm to about 10 μm, from about 500 nm to about 10 μm, from about 1 μm to about 10 μm, from about 5 μm to about 10 μm, from about 5 nm to about 5 μm, from about 10 nm to about 1 μm, from about 50 nm to about 900 nm, from about 100 nm to about 800 nm, from about 200 nm to about 700 nm, from about 300 nm to about 600 nm, or from about 400 nm to about 500 nm, but may not be limited thereto. If the pores have a size similar to a wavelength of light, a coating layer becomes opaque. Therefore, more desirably, the pores may have a size of several hundred nanometers or less which is much smaller than the wavelength of light.

In an exemplary embodiment of the present disclosure, the protective layer 500 including the pores may have a porosity of from about 20% to about 70%, but may not be limited thereto. For example, the porosity may be from about 20% to about 70%, from about 30% to about 70%, from about 40% to about 70%, from about 50% to about 70%, from about 60% to about 70%, from about 20% to about 60%, from about 20% to about 50%, from about 20% to about 40%, or from about 20% to about 30%, but may not be limited thereto. If the porosity of the protective layer is less than about 20%, the insulation effect may deteriorate. If the porosity of the protective layer is more than about 70%, the protective layer becomes opaque, and, thus, the optical properties of the transparent sheet heater may deteriorate.

In an exemplary embodiment of the present disclosure, when power is applied through the electrode 400, the heat-generating layer 300 generates heat.

In an exemplary embodiment of the present disclosure, the electrode 400 may be formed on the heat-generating layer 300 or the protective layer 500, but may not be limited thereto. The electrode 400 may include a pair or more of electrodes. The electrode 400 may be formed by various wet coating and dry coating processes. For example, the electrode 400 may be formed by gravure printing, flexo printing, comma printing, slit coating, spray coating, screen printing, offset printing, laminating, lift-off, sputtering, ion plating, chemical vapor deposition, plasma chemical vapor deposition, thermal deposition, laser molecular beam deposition, pulse laser deposition, or atomic layer deposition, but may not be limited thereto.

In an exemplary embodiment of the present disclosure, the electrode 400 may include any material without limitation as long as it is conductive, and may be, for example, transparent, but may not be limited thereto. For example, the electrode 400 may include a member selected from the group consisting of silver, gold, platinum, aluminum, copper, chromium, vanadium, magnesium, titanium, tin, lead, palladium, tungsten, nickel, alloys thereof, indium tin oxide (ITO), a metal nanowire, a carbon nanostructure, and combinations thereof, but may not be limited thereto. For example, the metal nanowire may include a metal nanowire selected from the group consisting of silver, gold, platinum, cooper, nickel, aluminum, titanium, palladium, cobalt, cadmium, rhodium, and combinations thereof, but may not be limited thereto. For example, the carbon nanostructure may include a member selected from the group consisting of graphene, carbon nanotube, fullerene, carbon black, and combinations thereof, but may not be limited thereto.

A third aspect of the present disclosure provides a transparent sheet heater system formed by connecting the multiple transparent sheet heaters according to the first or second aspect of the present disclosure in series or in parallel.

All the descriptions of the transparent sheet heater according to the first or second aspect of the present disclosure can be applied to the transparent sheet heater system according to the third aspect of the present disclosure, and detailed descriptions of the transparent sheet heater system, which overlap with those of the first or second aspect of the present disclosure, are omitted hereinafter, but the descriptions of the first or second aspect of the present disclosure may be identically applied to the third aspect of the present disclosure, even though they are omitted hereinafter.

### MODE FOR CARRYING OUT THE INVENTION

Hereinafter, the present disclosure will be described in more detail with reference to examples. The following examples are provided only for explanation, but do not intend to limit the scope of the present disclosure.

### EXAMPLES

### Example 1

A solution including a silver nanowire dispersed in water was stirred for 30 minutes. A PET substrate including an intaglio grid pattern having a width of 10 μm and a height of 10 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

### Example 2

A solution including a silver nanowire dispersed in water was stirred for 30 minutes. A PET substrate including a relief grid pattern having a width of 10 μm and a height of 10 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

### Example 3

A solution including a silver nanowire dispersed in water was stirred for 30 minutes. A PET substrate including an intaglio amorphous pattern having a width of 10 μm and a height of 10 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

### Example 4

A solution including a silver nanowire dispersed in water was stirred for 30 minutes. A PET substrate including an intaglio grid pattern having a width of 10 μm and a height of 100 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

### Example 5

A solution including a carbon nanotube (CNT) dispersed in water was stirred for 30 minutes. A PET substrate including an intaglio grid pattern having a width of 10 μm and a height of 10 μm was prepared and then bar-coated with the CNT-dispersed solution. The substrate wet-coated with the CNT was dried in an oven at 80° C. for 2 minutes to obtain a CNT film.

Then, the CNT film was bar-coated with an overcoating solution in an amount of 1.0 wt % and then dried at 100° C. and processed with 300 mJ in a UV curing apparatus to form a polymer film. Thus, a transparent conductive film including the CNT film and an overcoating layer on the substrate was obtained.

Then, electrodes were formed on both ends of the film via screen printing.

### Comparative Example 1

A solution including a silver nanowire dispersed in water was stirred for 30 minutes. A PET substrate without a pattern was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

### Test Example 1

9-point sheet resistances were measured from the heaters obtained in Examples 1 to 5 and Comparative Example 1 with a low resistivity meter (Loresta-GP MCP-T610, Mitsubishi Chemical Corporation) and a sheet resistance average value (Rs; Ω/□) was measured. Then, a uniformity (Rs uniformity; %) of the sheet resistances was calculated using a standard deviation value.

### Test Example 2

Visible light transmittances (%) and hazes (Hz; %) were measured from the heaters obtained in Examples 1 to 5 and Comparative Example 1 with a UV spectrometer (NDH2000, Nippon Denshoko).

### Test Example 3

Heat generation temperatures (° C.) were measured on the basis of an applied voltage of 12 V in order to evaluate exothermic properties of the heaters obtained in Examples 1 to 5 and Comparative Example 1.

### Test Example 4

On/Off tests were performed on the basis of an applied voltage of 12 V in order to evaluate heat generation lifetimes of the heaters obtained in Examples 1 to 5 and Comparative Example 1. The tests were performed to measure the number of times of turning on for 3 minutes and turning off for 2 minutes until disconnection on the basis of the time of reaching a final temperature.

The results of Test Examples 1 to 4 were as shown in the following Table 1.

TABLE 1

| | Transmittance | | Rs | Rs uniformity | Heat generation | |
|---|---|---|---|---|---|---|
| Classification | (%) | Hz (%) | (Ω/□) | (%) | temperature (° C.) | ON/OFF |
| Example 1 | 88 | 7.5 | 30 | 5 | 42 | 2,014 |
| Example 2 | 87 | 7.4 | 31 | 6 | 42 | 1,998 |
| Example 3 | 88 | 7.4 | 30 | 5 | 43 | 2,007 |
| Example 4 | 86 | 32 | 30 | 9 | 46 | 1,778 |
| Example 5 | 80 | 1.5 | 35 | 7 | 40 | 2,226 |
| Comparative | 88 | 2.5 | 31 | 10 | 48 | 677 |
| Example 1 | | | | | | |

As can be seen from Table 1, it was confirmed that the resistance uniformity (Rs) was greatly improved in the case where a substrate including a pattern was used as in Examples 1 to 5 as compared with the case where a substrate without a pattern was used (Comparative Example 1), and, thus, the exothermic properties were improved and the number of times until disconnection (On/Off) was greatly increased.

### Example 6

A solution including a silver nanowire dispersed in water was stirred for 30 minutes. A PET substrate including an intaglio grid pattern having a width of 10 μm and a height of 10 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

Then, a protective film was laminated on an upper end of the formed transparent heater.

### Example 7

A solution including a silver nanowire dispersed in water was stirred for 30 minutes. A PET substrate including a relief grid pattern having a width of 10 μm and a height of 10 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

Then, a protective film was laminated on an upper end of the formed transparent heater.

### Example 8

A solution including a silver nanowire dispersed in water was stirred for 30 minutes. A PET substrate including an intaglio amorphous pattern having a width of 10 μm and a height of 10 μm was prepared and then bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, electrodes were formed on both ends of the film via screen printing.

Then, a protective film was laminated on an upper end of the formed transparent heater.

### Example 9

A transparent conductive film was obtained using the same substrate by the same method as in Example 6.

Then, electrodes were formed on both ends of the film via screen printing.

Then, a protective film including pores of several hundred nm was laminated on an upper end of the formed transparent heater.

### Comparative Example 2

A transparent conductive film was obtained using the same substrate by the same method as in Example 6.

Then, electrodes were formed on both ends of the film via screen printing.

### Test Example 5

9-point sheet resistances were measured from the heaters obtained in Examples 6 to 9 and Comparative Example 2 with a low resistivity meter (Loresta-GP MCP-T610, Mitsubishi Chemical Corporation) before the porous films were laminated on the heaters, respectively, and a sheet resistance average value (Rs; Ω/□) was measured. Then, a uniformity of the sheet resistances (Rs uniformity; %) was calculated using a standard deviation value.

### Test Example 6

Visible light transmittances (%) and hazes (Hz; %) were measured from the heaters obtained in Examples 6 to 9 and Comparative Example 2 with a UV spectrometer (NDH2000, Nippon Denshoko).

### Test Example 7

ΔT (° C.) (heat generation temperature-atmospheric temperature) was measured on the basis of an applied voltage of 12 V in order to evaluate exothermic properties of the heaters obtained in Examples 6 to 9 and Comparative Example 2.

The results of Test Examples 5 to 7 were as shown in the following Table 2.

TABLE 2

| | Transmittance | Hz | Rs | Rs uniformity | ΔT |
|---|---|---|---|---|---|
| Classification | (%) | (%) | (Ω/□) | (%) | (° C.) |
| Example 6 | 88 | 5.5 | 30 | 5 | 10 |
| Example 7 | 87 | 5.7 | 31 | 4 | 12 |
| Example 8 | 88 | 5.8 | 30 | 5 | 13 |
| Example 9 | 86 | 6.0 | 30 | 5 | 14 |
| Comparative | 88 | 2.5 | 31 | 10 | 7 |
| Example 2 | | | | | |

As can be seen from Table 2, it was confirmed that a heater including an air gap and pores as in Examples 6 to 9 exhibited higher exothermic properties at the same voltage.

### Example 10

A solution including a silver nanowire dispersed in water was stirred for 30 minutes. A PET substrate was bar-coated with the silver nanowire-dispersed solution. The substrate wet-coated with the silver nanowire was dried in an oven at 80° C. for 2 minutes to obtain a silver nanowire film.

Then, the silver nanowire film was bar-coated with an overcoating solution in an amount of 1.0 wt % and then dried at 100° C. and processed with 300 mJ in a UV curing apparatus to form a polymer film. Thus, a transparent conductive film including the silver nanowire film and an overcoating layer on the substrate was obtained.

Then, a transparent heater was prepared by forming electrodes on both ends of the film via screen printing.

Then, a solution including a mixture of ethanol and acetone at a ratio of 6:4 was prepared as a solvent to prepare a porous film. Further, tetraethoxysilane (TEOS) was used as a silica precursor and hydrochloric acid was used as a catalyst. Also, cetyltrimethylammonium bromide (CTAB) was used as a surfactant and distilled water (DI-water) was further used. A molar ratio of TEOS, ethanol, DI-water, hydrochloric acid, and CTAB was as follows.

TEOS:ethanol:DI-water:hydrochloric acid:CTAB=1:20:5:0.005:0.03

After ethanol and acetone were mixed, DI-water and hydrochloric acid were added. Then, CTAB previously melted at 70° C. was added thereto and stirred for 2 hours. TEOS was put into the stirred solution and stirred at room temperature for 30 minutes and then spin-coated on a glass substrate. In this case, a spin rate was 3,000 rpm, and the spin-coating was performed for 30 seconds. The solvent was evaporated from the coated thin film at room temperature for a day. Then, the thin film was heat-treated at 150° C. to decompose the surfactant. Thus, a porous film including multiple pores with a porosity of 30% was obtained.

Then, the prepared porous protective film was laminated on an upper end of the heater where electrodes were formed.

### Example 11

A transparent heater was prepared by the same method as in Example 10, and a porous film was prepared with the following molar ratio.

TEOS:ethanol:DI-water:hydrochloric acid:CTAB=1:20:5:0.005:0.05

Then, the porous film with a porosity of about 40% was obtained.

Then, the prepared porous protective film was laminated on an upper end of the heater where electrodes were formed.

### Example 12

A transparent heater was prepared by the same method as in Example 10, and a porous film was prepared with the following molar ratio.

TEOS:ethanol:DI-water:hydrochloric acid:CTAB=1:20:5:0.005:0.07

Then, the porous film with a porosity of about 50% was obtained.

Then, the prepared porous protective film was laminated on an upper end of the heater where electrodes were formed.

### Comparative Example 3

A transparent heater was prepared by the same method as in Example 10, but a porous protective film was not laminated thereon.

### Test Example 8

9-point sheet resistances were measured from the transparent heaters obtained in Examples 10 to 12 and Comparative Example 3 with a low resistivity meter (Loresta-GP MCP-T610, Mitsubishi Chemical Corporation) before the porous films were laminated on the transparent heaters, respectively, and a sheet resistance average value (Rs; Ω/□) was measured. Then, a uniformity of the sheet resistances (Rs uniformity; %) was calculated using a standard deviation value.

### Test Example 9

Visible light transmittances (%) and hazes (Hz; %) were measured from the transparent heaters obtained in Examples 10 to 12 and Comparative Example 3 with a UV spectrometer (NDH2000, Nippon Denshoko).

### Test Example 10

ΔT (° C.) (heat generation temperature-atmospheric temperature) was measured on the basis of an applied voltage of 12 V in order to evaluate exothermic properties of the transparent heaters obtained in Examples 10 to 12 and Comparative Example 3.

The results of Test Examples 8 to 10 were as shown in the following Table 3.

TABLE 3

| | Transmittance | Hz | Rs | Rs uniformity | ΔT |
|---|---|---|---|---|---|
| Classification | (%) | (%) | (Ω/□) | (%) | (° C.) |
| Example 10 | 88 | 1.6 | 30 | 7 | 10 |
| Example 11 | 87 | 1.5 | 31 | 6 | 12 |
| Example 12 | 87 | 1.5 | 30 | 5 | 13 |
| Comparative | 88 | 1.4 | 31 | 7 | 7 |
| Example 3 | | | | | |

As can be seen from Table 3, it was confirmed that a heater including a protective film with pores as in Examples 10 to 12 exhibited higher exothermic properties at the same voltage.

The present disclosure has been described in detail with reference to the exemplary embodiments and examples. However, it is clear that the present disclosure is not limited to the above exemplary embodiments and examples and can be modified in various forms by those skilled in the art within a technical concept of the present disclosure.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A transparent sheet heater comprising:
a substrate;
a pattern layer formed on the substrate;
a heat-generating layer formed on the pattern layer and including a conductive material; and
an electrode connected on the heat-generating layer.

2. A transparent sheet heater comprising:
a substrate;
a heat-generating layer formed on the substrate and including a conductive material;
an electrode connected on the heat-generating layer; and
a protective layer formed on the heat-generating layer,
wherein the protective layer includes pores.

3. The transparent sheet heater of claim 1,
wherein the pattern layer is formed of a curable resin.

4. The transparent sheet heater of claim 1,
wherein the pattern layer has a shape selected from the group consisting of intaglio, relief, and combinations thereof.

5. The transparent sheet heater of claim 1,
wherein the pattern layer includes a pattern with a gap of from 1 μm to 500 μm.

6. The transparent sheet heater of claim 1,
wherein the conductive material includes a member selected from the group consisting of a metal oxide, a metal nanowire, a carbon nanostructure, a metal paste, metal nanoparticles, and combinations thereof.

7. The transparent sheet heater of claim 6,
wherein the metal oxide includes a metal oxide selected from the group consisting of indium tin oxide, zinc tin oxide, indium gallium zinc oxide, zinc aluminum oxide, indium zinc oxide, zinc oxide, and combinations thereof.

8. The transparent sheet heater of claim 6,
wherein the metal nanowire includes a metal nanowire selected from the group consisting of silver, gold, platinum, cooper, nickel, aluminum, titanium, palladium, cobalt, cadmium, rhodium, and combinations thereof.

9. The transparent sheet heater of claim 6,
wherein the carbon nanostructure includes a member selected from the group consisting of graphene, carbon nanotube, fullerene, carbon black, and combinations thereof.

10. The transparent sheet heater of claim 6,
wherein the metal paste includes a metal selected from the group consisting of silver, gold, platinum, cooper, nickel, aluminum, titanium, palladium, cobalt, cadmium, rhodium, and combinations thereof.

11. The transparent sheet heater of claim 6,
wherein the metal nanoparticles include a metal selected from the group consisting of silver, gold, platinum, cooper, nickel, aluminum, titanium, palladium, cobalt, cadmium, rhodium, and combinations thereof.

12. The transparent sheet heater of claim 2,
wherein the pores in the protective layer have a size of 5 nm to 10 μm.

13. The transparent sheet heater of claim 1, further comprising:
a protective layer formed on the heat-generating layer.

14. The transparent sheet heater of claim 13, further comprising:
wherein the heat-generating layer is formed along a pattern shape of the pattern layer.

15. The transparent sheet heater of claim 14, further comprising:
an air gap formed between the protective layer and the heat-generating layer formed along the pattern shape.

16. The transparent sheet heater of claim 13,
wherein the protective layer includes pores.

17. The transparent sheet heater of claim 2,
wherein the conductive material includes a member selected from the group consisting of a metal oxide, a metal nanowire, a carbon nanostructure, a metal paste, metal nanoparticles, and combinations thereof.

18. The transparent sheet heater of claim 17,
wherein the metal oxide includes a metal oxide selected from the group consisting of indium tin oxide, zinc tin oxide, indium gallium zinc oxide, zinc aluminum oxide, indium zinc oxide, zinc oxide, and combinations thereof.

19. The transparent sheet heater of claim 17,
wherein the metal nanowire includes a metal nanowire selected from the group consisting of silver, gold, platinum, cooper, nickel, aluminum, titanium, palladium, cobalt, cadmium, rhodium, and combinations thereof.

20. The transparent sheet heater of claim 17,
wherein the carbon nanostructure includes a member selected from the group consisting of graphene, carbon nanotube, fullerene, carbon black, and combinations thereof.

21. The transparent sheet heater of claim 17,
wherein the metal paste includes a metal selected from the group consisting of silver, gold, platinum, cooper, nickel, aluminum, titanium, palladium, cobalt, cadmium, rhodium, and combinations thereof.

22. The transparent sheet heater of claim 17,
wherein the metal nanoparticles include a metal selected from the group consisting of silver, gold, platinum, cooper, nickel, aluminum, titanium, palladium, cobalt, cadmium, rhodium, and combinations thereof.
